(19) United States
(12) Patent Application Publication
(10) Pub. No.: US 2013/0195033 A1
(43) Pub. Date: Aug. 1, 2013

(54) Apparatus and Method for Optimization of Access Stratum Bearer Signaling in Radio Resource Control Connection Establishment

(71) Applicants: Jussi-Pekka Koskinen, Oulu (FI); Jarkko Koskela, Oulu (FI)

(72) Inventors: Jussi-Pekka Koskinen, Oulu (FI); Jarkko Koskela, Oulu (FI)

(73) Assignee: NOKIA CORPORATION, Espoo (FI)

(21) Appl. No.: 13/638,698

(22) PCT Filed: Apr. 1, 2011
(86) PCT No.: PCT/IB11/51421

§ 371 Date: Feb. 15, 2013

Related U.S. Application Data
(60) Provisional application No. 61/320,099, filed on Apr. 1, 2010.

(51) Int. Cl. H04W 76/02

(52) U.S. Cl. CPC H04W 76/02
USPC 370/329

(57) ABSTRACT

In accordance with an example embodiment of the present invention, a method is disclosed that comprises receiving at a network element a request message from a user equipment to establish a connection with the user equipment, and in response to the received request message, generating a reply message including an access stratum bearer information without contacting another network element.

### RELATED APPLICATIONS

This application relates to U.S. Application filing Ser. No. 61/310515, entitled, “Method and Apparatus for Efficiently Providing for Security During Connection Establishment”, filed on Mar. 4, 2010, which is hereby incorporated by reference in its entirety.

### TECHNICAL FIELD

The present application relates generally to an apparatus and a method for optimization of access stratum bearer signaling in radio resource control (RRC) connection establishment.

### BACKGROUND

This section is intended to provide a background or context to the invention that is recited in the claims The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

In wireless communication, different collections of communication protocols are available to provide different types of services and capabilities. The long term evolution (LTE) is one of such collection of wireless communication protocols that extends and improves the performance of existing UMTS (universal mobile telecommunications system) protocols and is specified by different releases of the standard by the 3^{rd} generation partnership project (3GPP) in the area of mobile network technology.

One specification of interest is 3GPP TS 36.300, V8.11.0 (2009-12), “3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8),” incorporated by reference herein in its entirety. This system may be referred to for convenience as LTE Rel-8.Recently, Release 9 versions of at least some of LTE specifications have been published including 3GPP TS 36.300, V9.2.0 (2009-12).

Of interest herein are the further releases of 3GPP LTE (e.g., LTE Rel-10) targeted towards future international mobile telephony-advanced (IMT-A) systems, referred to herein for convenience simply as LTE-Advanced (LTE-A). Reference in this regard may be made to 3GPP TR 36.913, V8.0.1 (2009-03), 3rd Generation Partnership Project; Technical Specification Group Radio Access Network; Requirements for Further Advancements for E-UTRA (LTE-Advanced) (Release 8). A goal of LTE-A is to provide significantly enhanced services by means of higher data rates and lower latency with reduced cost. LTE-A is directed toward extending and optimizing the 3GPP LTE Rel-8 radio access technologies to provide higher data rates at very low cost. LTE-A will be a more optimized radio system fulfilling the international telecommunication union radiocommucation sector (ITU-R) requirements for IMT-A while maintaining backward compatibility with LTE Rel-8.

In the context of LTE, two strata are defined: non-access stratum (NAS) and access stratum (AS). The NAS is a protocols set including the protocols for mobility management and session management between the user equipment (UE) and mobility management entity (MME). The AS provides reliable in-sequence delivery of NAS messages in a cell. This includes the functions and protocols for the transport of information across the E-UTRAN and air interface. When a connection between the UE and the communication network is established, an AS bearer is normally allocated through control signaling. One of topics discussed in LTE-A is to further reduce the signaling overhead and enable a faster connection establishment between the user equipment and the communication network.

### SUMMARY

Various aspects of examples of the invention are set out in the claims.

According to a first aspect of the present invention, a method may include receiving at a network element a request message from a user equipment to establish a connection with the user equipment; and in response to the received request message, generating a reply message including an access stratum bearer information without contacting another network element.

According to a second aspect of the present invention, an apparatus may include at least one processor, and at least one memory including computer program code, wherein the at least one memory and the computer program code configured to, with the at least one processor, cause the apparatus at least to perform receive at a network element a request message from a user equipment to establish a connection with the user equipment; and in response to the received request message, generate a reply message including an access stratum bearer information without contacting another network element.

According to a third aspect of the present invention, a computer program product comprising a computer-readable medium bearing computer program code embodied therein for use with a computer, the computer program code may include code for receiving at a network element a request message from a user equipment to establish a connection with the user equipment; and in response to the received request message, code for generating a reply message including an access stratum bearer information without contacting another network element.

According to a fourth aspect of the present invention, an apparatus may include a means for receiving at a network element a request message from a user equipment to establish a connection with the user equipment; and in response to the received request message, a means for generating a reply message including an access stratum bearer information without contacting another network element.

### BRIEF DESCRIPTION OF THE DRAWINGS

For a more complete understanding of example embodiments of the present invention, reference is now made to the following descriptions taken in connection with the accompanying drawings in which:

FIG. 1 illustrates the overall architecture of an example Evolved Universal Terrestrial Access Network (E-UTRAN) system together with evolved packet core elements and user equipments;

FIG. 2 shows a simplified control plane protocol stack in an example E-UTRAN system;

FIG. 3 shows a simplified message sequence for establishing a new connection between a user equipment and a communication network in accordance with an example embodiment of the invention; and

FIG. 4 illustrates a simplied block diagram of various electronic apparatus in accordance with an example embodiment of the invention.

### DETAILED DESCRIPTON

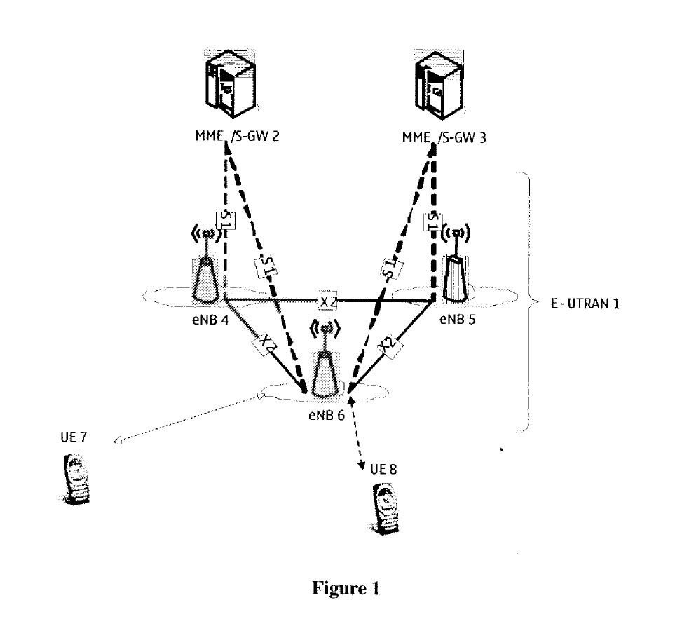

FIG. 1 illustrates the overall architecture of an example Evolved Universal Terrestrial Access Network (E-UTRAN) system 1 together with evolved packet core (EPC) elements and user equipments. System 1 provides an enviorment for the application of the principles of embodiments of the present invention.

The E-UTRAN system 1 includes E-UTRAN node Bs (eNBs) 4, 5 and 6, providing the E-UTRAN user plane and control plane protocol communications towards the user equipments (UEs) 7 and 8. The eNBs are interconnected with each other by means of an X2 interface. The eNBs are also connected by means of an S1 interface to anEPC. For example, the eNBs may connect to a mobility management entity (MME) by a S1-MME interface and to a serving gateway (S-GW) by a S1-U interface, for example, the MMEs/S-GWs 2 and 3 of FIG. 1. The S1 interface supports a many-to-many relationship between MMEs/S-GWs and eNBs.

The eNBs 4, 5 and 6 host one or more of the following functions:
Functions for radio resource management: radio bearer control, radio admission control, connection mobility control, dynamic allocation of resources to UEs in both uplink and downlink scheduling;
Internet protocol (IP) header compression and encryption of user data stream;
Selection of an MME at UE attachment when no routing to an MME can be determined from the information provided by the UE;
Routing of user plane data towards serving gateway;
Scheduling and transmission of paging messages (originated from the MME);
Scheduling and transmission of broadcast information (originated from the MME or operations and maintenance (O&M));
Measurement and measurement reporting configuration for mobility and scheduling;
Scheduling and transmission of public warning system (PWS) (which includes earthquake and tsunami warning system (ETWS) and commercial mobile alert service (CMAS)) messages (originated from the MME).

The MMEs 2 and 3 hosts one or more of the following functions:
Non-access stratum (NAS) signaling;
NAS signaling security;
Access stratum (AS) security control;
Inter core network (CN) node signaling for mobility between 3^{rd} generation partnership project (3GPP) access networks;
Idle mode UE Reachability (including control and execution of paging retransmission);
Tracking area list management (for UE in idle and active mode);
Public data network (PDN) GW and S-GW selection;
MME selection for handovers with MME change;
Serving general packet radio service support node (SGSN) selection for handovers to the second generation or the third generation 3GPP access networks;
Roaming;
Authentication;
Bearer management functions including dedicated bearer establishment;
Support for PWS (which includes ETWS and CMAS) message transmission.

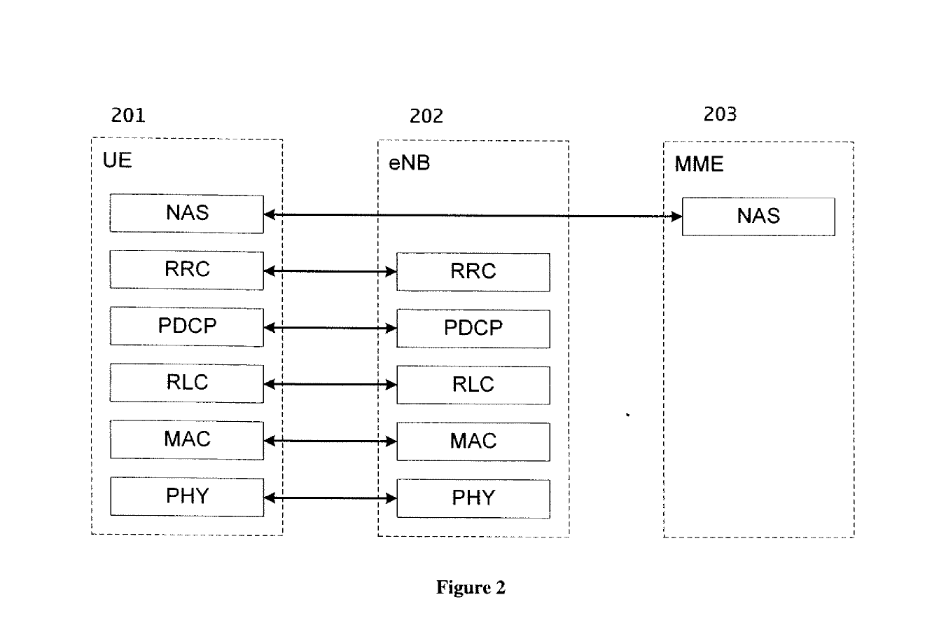

FIG. 2 depicts a simplified control plane protocol stack in an E-UTRAN system for a UE 201, an eNB 202, and an MME 203. The UE 201 and the eNB 202 each include one or more of the following sublayers: a physical sublayer (PHY), a medium access control sublayer (MAC), a radio link control sublayer (RLC), a packet data convergence protocol sublayer (PDCP), and a radio resource control sublayer (RRC). Additionally, the UE and the MME include a NAS sublayer. The NAS sublayer sits on top of the RRC sublayer in the UE. As can be seen in FIG. 2, NAS signaling exchange takes place transparently through the radio acess network, for example, the eNB will not interpret these messages. The NAS messages are carried inside or sent concatenated with RRC message when transmitted over a radio interface.

When a UE wishes to send or receive control signaling or data to or from the network, an RRC connection is used. The RRC connection procedure is generally coordinated with a NAS signaling procedure, for example, an attach procedure, resulting in the establishment of basic IP-connectivity for the UE. In the context of LTE, the exchange of control signaling or data is carried by the evolved packet system (EPS) bearer. In an example embodiment, an AS bearer is defined as a data radio bearer (DRB) established for the radio interface between the UE and the radio access network element, e.g., the eNB 202. In an example embodiment, an AS bearer is mapped to an EPS bearer, or alternatively, may be considered as the radio part of the EPS bearer. In an example embodiment, an EPS/AS bearer is an information transmission path of defined capacity, delay and bit error rate, etc. between the UE and the network. During the establishment of the RRC connection and the attach procedure, at least one EPS/AS bearer will be allocated to the UE. This bearer is referred to as the default bearer and it remains established throughout the lifetime of the conection to provide the UE with always-on IP connectivity to the network. Any additional EPS/AS bearer that is established for the same connection is referred to as a dedicated bearer.

According to the current LTE Rel-8/9 specifications the default EPS/AS bearer is to be signaled explicitly every time when RRC connection is established for data transfer. The signaling exchanges between the UE and eNB are normally time-consuming. Especially there is extensive delay when the eNB is to contact an MME to get the UE context.

To reduce the signaling overhead and enable a faster connection establishment between the user equipment and the communication network, optimization for AS bearer signaling in RRC connection establishment is desirable. In an example embodiment, signalling is optimized in case of connection establishment without need for separate signaling messages for the AS bearer and its corresponding DRB establishment. In order to speed up the connection establishment, in an example embodiment, it would be beneficial to establish an AS bearer by the eNB without contacting the MME. In an example embodiment, the eNB establishes an AS bearer that is linked to the default EPS bearer without time consuming signaling.

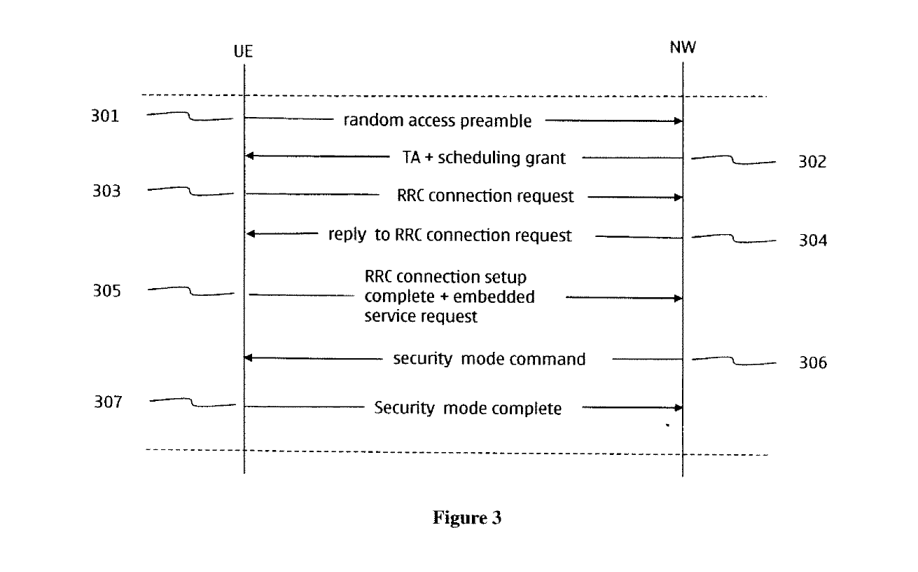

FIG. 3 shows a simplified message sequence for establishing a new connection between a user equipment, for example, the UE 7 or 8 of FIG. 1, or the UE 201 of FIG. 2, and a communication network (NW) in accordance with an example embodiment of the invention.

At 301, the UE initiates its access to the network by sending a random access preamble on a random access channel (RACH) to the network, for example, to a radio access network element, for example, the eNB 6 of FIG. 1, or the eNB 202 of FIG. 2. At 302 the eNB sends back the scheduling grant to the UE. In an example embodiment, the eNB also sends back together with the scheduling grant, a timing advance (TA) to the UE. The TA is used to time synchronize the UE with the network.

At 303, the UE sends an RRC connection request message, for example, an RRCConnectionRequest message, to the eNB by using the received scheduling grant to request the establishment of the RRC connection between the UE and the network. If the eNB grants the RRC connection request, the eNB sends at 304 a message, for example, a RRCConnectionSetup message, to the UE.

According to an example embodiment, if the UE indicates at 303 that it is establishing connection for sending/receiving data, the network may indicate the AS bearer establishment in a reply message, for example, an RRCConnectionSetup message, transmitted from the network to the UE at 304. In an example embodiment, the RRCConnectionSetup message contains the information regarding the DRB corresponding to the default EPS bearer. In an example embodiment, the DRB is mapped to the default EPS bearer implicitly, because only one bearer is established during this procedure. In another example embodiment, there is an explicit indication in the message indicating that this DRB should be mapped to the default EPS bearer. In an example embodiment, the radio access network element, for example, the eNB 6 of FIG. 1, or the eNB 202 of FIG. 2, is responsible for establishment of the AS bearer corresponding to the default EPS bearer and transmitting the information regarding the AS bearer in the RRCConnectionSetup message, without contacting another network entity, for example, the MME 2 or 3 of FIG. 1, or the MME 203 of FIG. 2.

The UE may perform the radio resource configuration in accordance with the received information in the reply message, for example, the RRCConnectionSetup message. The UE prepares a RRC connection setup complete message, for example, an RRCConnectionSetupComplete message, and at 305 transmits it to the eNB. In the RRC connection setup complete message, the UE may put a service request, for example, a NAS SERVICE REQUEST. In one example embodiment, the NAS SERVICE REQUEST is an attach request. After receiving the service request, the network may check whether to update any parameters related to the EPS/AS bearer that has been established and informed to the UE at 304. From the air interface message flow presented herein, it seems that the NAS sublayer of the UE receives DRB setup before NAS SERVICE REQUEST is sent. However, this does not incur any problem because from NAS perspective, the NAS SERVICE REQUEST has already been sent when it provides the message to the lower sublayers.

In response to the received attach request, before data transfer is started, the network, for example, the E-UTRAN and the MME, performs an authentication and security activation procedure to protect the network against unauthrozied use and also to protect the subscribers by denyinig the possibility for intruders to impersonate valid users. In an example embodiment, this procedure involves sending a security mode command message, for example, a SecurityModeCommand message from the network to the UE at 306 and receiving a security mode complete message, for example, a SecurityModeComplete message from the UE as an indication of successful authentication and security activation at 307. In another example embodiment, the security may be alternatively activated as described in the related application with US Patent Application Ser. No. 61/310515, entitled “Method and Apparatus for Efficiently Providing for Security During Connection Establishment”.

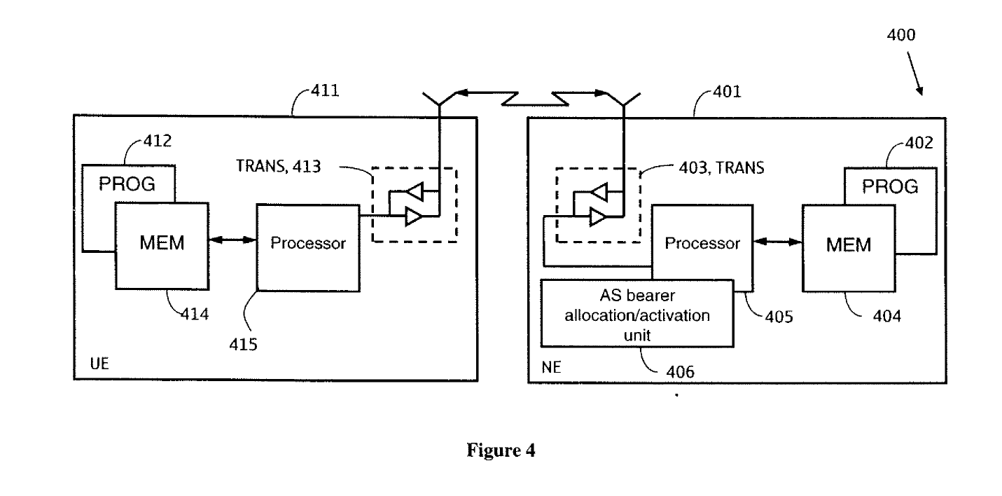

FIG. 4 illustrates a simplified block diagram of various exemplary electronic devices that are suitable for use in practicing the exemplary embodiments of this invention. In FIG. 4, a wireless network 400 is adapted for communication with a UE 411 via a network element (NE) 401, e.g., the eNB 6 of FIG. 1, or the eNB 202 of FIG. 2. The UE 411 includes a processor 415, a memory (MEM) 414 coupled to the processor 415, and a suitable transceiver (TRANS) 413 (having a transmitter (TX) and a receiver (RX)) coupled to the processor 415. The MEM 414 stores a program (PROG) 412. The TRANS 413 is for bidirectional wireless communications with the NE 401.

The NE 401 includes a processor 405, a memory (MEM) 404 coupled to the processor 405, and a suitable transceiver (TRANS) 403 (having a transmitter (TX) and a receiver (RX)) coupled to the processor 405. The MEM 404 stores a program (PROG) 402. The TRANS 403 is for bidirectional wireless communications with the UE 411. The NE 401 is coupled to one or more external networks or systems, e.g., the MME 2 or 3 of FIG. 1, or the MME 203 of FIG. 2, which is not shown in this figure.

As shown in FIG. 4, the NE 411 may further include an AS bearer allocation/activation unit 406, which in response to a received RRC connection request message, allocates and activates an AS bearer for the UE without contacting another network element, e.g., the MME. The AS bearer allocation/activation unit may be utilized by the NE 401 in conjunction with various exemplary embodiments of the invention, as described herein.

At least one of the PROGs 402, 412 is assumed to include program instructions that, when executed by the associated processor, enable the electronic device to operate in accordance with the exemplary embodiments of this invention, as discussed herein.

In general, the various example embodiments of the apparatus 411 may include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by one or more of the processors 405, 415 of the NE 401 and the UE 411, or by hardware, or by a combination of software and hardware.

The MEMs 404, 414 may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The processors 405, 415 may be of any type suitable to the local technical environment, and may include one or more of general purpose computers, special purpose computers, microprocessors, digital signal processors (DSPs) and processors based on multi-core processor architecture, as non-limiting examples.

Without in any way limiting the scope, interpretation, or application of the claims appearing below, a technical effect of one or more of the example embodiments disclosed herein may be allowing a radio access network element, e.g., an eNB, to allocate and activate an EPS/AS bearer for a UE in response to a received message requesting the establishment of a connection between the UE and the communication network, without contacting another network element, e.g., an MME. This allows an improvement on the latency of control plane signaling and reduction of signaling overhead.

Embodiments of the present invention may be implemented in software, hardware, application logic or a combination of software, hardware and application logic.

The software, application logic and/or hardware may reside on an apparatus such as a user equipment 411, an eNode B/base station 401 or other mobile communication devices. If desired, part of the software, application logic and/or hardware may reside on an eNode B/base station 401, part of the software, application logic and/or hardware may reside on a user equipment 411, and part of the software, application logic and/or hardware may reside on other chipset or integrated circuit. In an example embodiment, the application logic, software or an instruction set is maintained on any of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

Although various aspects of the invention are set out in the independent claims, other aspects of the invention comprise other combinations of features from the described embodiments and/or the dependent claims with the features of the independent claims, and not solely the combinations explicitly set out in the claims

It is also noted herein that while the above describes example embodiments of the invention, these descriptions should not be viewed in a limiting sense. Rather, there are several variations and modifications which may be made without departing from the scope of the present invention as defined in the appended claims

For example, while the example embodiments have been described above in the context of the LTE-A system, it should be appreciated that the example embodiments of this invention are not limited for use with only this one particular type of wireless communication system, and that they may be used to advantage in other wireless communication systems.

Further, the various names used for the described parameters or messages are not intended to be limiting in any respect, as these parameters may be identified by any suitable names. Further, the various names assigned to different channels (e.g., RACH, etc.) are not intended to be limiting in any respect, as these various channels may be identified by any suitable names.

If desired, the different functions discussed herein may be performed in a different order and/or concurrently with each other. Furthermore, if desired, one or more of the above-described functions may be optional or may be combined. As such, the foregoing description should be considered as merely illustrative of the principles, teachings and example embodiments of this invention, and not in limitation thereof.

1-21. (canceled)

22. A method, comprising:
receiving at a network element a request message from a user equipment to establish a connection with the user equipment; and
in response to the received request message, generating a reply message including an access stratum bearer information without contacting another network element.

23. The method of claim 22, wherein the request message is a radio resource control connection request message and the reply message is a radio resource control setup message.

24. The method of claim 22, wherein the network element is an evolved base station and the another network element is a mobility management entity.

25. The method of claim 22, wherein the access stratum bearer is mapped to a default evolved packet system bearer.

26. The method of claim 25, wherein the reply message comprises an indication indicating that the access stratum bearer is mapped to the default evolved packet system bearer.

27. The method of claim 22, further comprising:
receiving a second message from the user equipment, said second message being in response to the reply message, wherein the second message comprises a non-access stratum service request; and
determining whether to update any parameters related to the access stratum bearer based on the non-access stratum service request.

28. The method of claim 27, further comprising:
updating the parameters related to the access stratum bearer based at least in part on the determined result.

29. An apparatus, comprising:
at least one processor;
and at least one memory including computer program code,
wherein the at least one memory and the computer program code are configured to, with the at least one processor, cause the apparatus at least to perform:
receive at a network element a request message from a user equipment to establish a connection with the user equipment; and
in response to the received request message, generate a reply message including an access stratum bearer information without contacting another network element.

30. The apparatus of claim 29, wherein the request message is a radio resource control connection request message and the reply message is a radio resource control setup message.

31. The apparatus of claim 29, wherein the network element is an evolved base station and the another network element is a mobility management entity.

32. The apparatus of claim 29, wherein the access stratum bearer is mapped to a default evolved packet system bearer.

33. The apparatus of claim 32, wherein the reply message includes an indication indicating that the access stratum bearer is mapped to the default evolved packet system bearer.

34. The apparatus of claim 29, wherein the at least one memory and the computer program code are configured to, with the at least one processor, cause the apparatus at least to further perform:
receive a second message from the user equipment, said second message being in response to the reply message, wherein the second message comprises a non-access stratum service request, and determine whether to update any parameters related to the access stratum bearer based on the non-access stratum service request.

35. The apparatus of claim 34, wherein the at least one memory and the computer program code are configured to, with the at least one processor, cause the apparatus at least to further perform:
update the parameters related to the access stratum bearer based at least in part on the determined result.

36. A computer program product comprising a computer-readable medium bearing computer program code embodied therein for use with a computer, the computer program code comprising:
code for receiving at a network element a request message from a user equipment to establish a connection with the user equipment; and
in response to the received request message, generating a reply message including an access stratum bearer information without contacting another network element.

37. The computer program product of claim 36, wherein the request message is a radio resource control connection request message, the reply message is a radio resource control setup message, the network element is an evolved base station and the another network element is a mobility management entity.

38. The computer program product of claim 36, wherein the access stratum bearer is mapped to a default evolved packet system bearer.

39. The computer program product of claim 38, wherein the reply message includes an indication indicating that the access stratum bearer is mapped to the default evolved packet system bearer.

40. The computer program product of claim 36, wherein the computer program code further comprises:
code for receiving a second message from the user equipment, said second message being in response to the reply message, wherein the second message comprises a non-access stratum service request, and determining whether to update any parameters related to the access stratum bearer based on the non-access stratum service request.

41. The computer program product of claim 40, wherein the computer program code further comprises:
code for updating the parameters related to the access stratum bearer based at least in part on the determined result.
